(19) United States
(12) Patent Application Publication
(10) Pub. No.: US 2013/0122724 A1
(43) Pub. Date: May 16, 2013

(54) CONNECTABLE LIGHTING APPARATUS

(71) Applicant: American DJ Supply, Inc., Los Angeles, CA (US)

(72) Inventor: Toby Velazquez, Yorba Linda, CA (US)

(73) Assignee: AMERICAN DJ SUPPLY, INC., Los Angeles, CA (US)

(21) Appl. No.: 13/670,400

(22) Filed: Nov. 6, 2012

Related U.S. Application Data
(60) Provisional application No. 61/559,698, filed on Nov. 14, 2011.

(51) Int. Cl. H01R 11/30

(52) U.S. Cl. 439/39

(57) ABSTRACT

Embodiments of the present invention provide a lighting apparatus comprising a housing for maintaining one or more lighting elements, and a mating mechanism for connecting the lighting apparatus to at least one other lighting apparatus. The mating mechanism magnetically couples the lighting apparatus to another lighting apparatus positioned within proximity of the mating mechanism.

### CROSS-REFERENCE TO RELATED APPLICATIONS

This application claims priority from U.S. Provisional Patent Application Ser. No. 61/559,698, filed on Nov. 14, 2011, incorporated herein by reference.

### BACKGROUND OF THE INVENTION

1. Field of the Invention

The present invention relates generally to lighting apparatuses, and in particular, to a connectable lighting apparatus.

2. Description of Related Art

Lighting apparatuses are used for illuminating both indoor and outdoor environments. Proper illumination is vital when filming movies, television shows, shooting videos, taking photographs, lighting live stage performances, and other similar activities.

### BRIEF SUMMARY OF THE INVENTION

Embodiments of the present invention provide a lighting apparatus comprising a housing for maintaining one or more lighting elements, and a mating mechanism for connecting the lighting apparatus to at least one other lighting apparatus. The mating mechanism magnetically couples the lighting apparatus to another lighting apparatus positioned within proximity of the mating mechanism.

In another embodiment, the present invention provides a lighting system comprising a plurality of lighting apparatuses. Each lighting apparatus comprises a housing for maintaining one or more lighting elements, and a mating mechanism for connecting said lighting apparatus to at least one other lighting apparatus. Each mating mechanism of each lighting apparatus magnetically couples said lighting apparatus to another lighting apparatus positioned within proximity of said mating mechanism.

In yet another embodiment, the present invention connects a lighting apparatus to another lighting apparatus by positioning said another lighting apparatus within proximity of a mating mechanism of the lighting apparatus. The mating mechanism magnetically couples said another lighting apparatus to the lighting apparatus.

These and other features, aspects and advantages of the present invention will become understood with reference to the following description, appended claims and accompanying figures.

### BRIEF DESCRIPTION OF THE DRAWINGS

FIG. 1 illustrates a front perspective view of a lighting apparatus, in accordance with an embodiment of the present invention.

FIG. 2A illustrates a side perspective view of a first end of a lighting apparatus, in accordance with an embodiment of the present invention.

FIG. 2B illustrates a magnetic connector member of a lighting apparatus, in accordance with an embodiment of the invention.

FIG. 2C illustrates a metallic connector member of a lighting apparatus, in accordance with an embodiment of the invention.

FIG. 3A illustrates a top perspective view of a lighting apparatus, in accordance with an embodiment of the invention.

FIG. 3B illustrates a bottom perspective view of a first end of a lighting apparatus, in accordance with an embodiment of the invention.

FIG. 3C illustrates a bottom perspective view of a second end of a lighting apparatus, in accordance with an embodiment of the invention.

FIG. 3D is a block diagram illustrating a control module of a lighting apparatus, in accordance with an embodiment of the invention.

FIG. 4A illustrates a bottom perspective view of a lighting apparatus, in accordance with an embodiment of the present invention.

FIG. 4B illustrates a mounting device of a lighting apparatus, in accordance with an embodiment of the present invention.

FIG. 5A illustrates multiple lighting apparatuses, in accordance with an embodiment of the invention.

FIG. 5B illustrates multiple lighting apparatuses arranged end-to-end in an example daisy-chain configuration, in accordance with an embodiment of the invention.

FIG. 6 is a block diagram illustrating multiple lighting apparatuses arranged in a parallel lighting circuit, in accordance with an embodiment of the invention.

FIG. 7 is a block diagram illustrating multiple lighting apparatuses linked in a daisy-chain lighting circuit, in accordance with an embodiment of the invention.

### DETAILED DESCRIPTION OF THE INVENTION

Embodiments of the present invention provide a lighting apparatus comprising a housing for maintaining one or more lighting elements, and a mating mechanism for connecting the lighting apparatus to at least one other lighting apparatus. The mating mechanism magnetically couples the lighting apparatus to another lighting apparatus positioned within proximity of the mating mechanism.

In another embodiment, the present invention provides a lighting system comprising a plurality of lighting apparatuses. Each lighting apparatus comprises a housing for maintaining one or more lighting elements, and a mating mechanism for connecting said lighting apparatus to at least one other lighting apparatus. Each mating mechanism of each lighting apparatus magnetically couples said lighting apparatus to another lighting apparatus positioned within proximity of said mating mechanism.

In yet another embodiment, the present invention connects a lighting apparatus to another lighting apparatus by positioning said another lighting apparatus within proximity of a mating mechanism of the lighting apparatus. The mating mechanism magnetically couples said another lighting apparatus to the lighting apparatus.

The lighting apparatuses connect together when a mating mechanism of each lighting apparatus magnetically couples to a mating mechanism of another lighting apparatus. In one example configuration, the lighting apparatuses are connected end-to-end.

In one embodiment, each mating mechanism of each lighting apparatus comprises a magnetic connector member at a first end of the housing of said lighting apparatus, and a metallic connector member at a second end of the housing of said lighting apparatus. Each magnetic connector member comprises a magnet having a magnetic field. Each magnetic connector member magnetically attracts another metallic connector member positioned within proximity of the magnetic field of said magnetic connector member.

The first end of each lighting apparatus magnetically couples to another lighting apparatus when the magnetic connector member of said lighting apparatus magnetically attracts a metallic connector member of said another lighting apparatus. The second end of each lighting apparatus magnetically couples to another lighting apparatus when the metallic connector member of said lighting apparatus is magnetically attracted to a magnetic connector member of said another lighting apparatus.

In another embodiment, each mating mechanism of each lighting apparatus comprises a first magnetic connector member at a first end of the housing of said lighting apparatus, and a second magnetic connector member at a second end of the housing of said lighting apparatus. The first magnetic connector member has a first magnetic pole, and the second magnetic connector member has a second magnetic pole that is opposite of the first magnetic pole. Each magnetic connector member comprises a magnet having a magnetic field. Each magnetic connector member magnetically attracts an opposite poled magnetic connecter member positioned within proximity of the magnetic field of said magnetic connector member.

The first end of each lighting apparatus magnetically couples to another lighting apparatus when a magnetic connector member of said lighting apparatus magnetically attracts an opposite poled magnetic connector member of said another lighting apparatus. The second end of each lighting apparatus magnetically couples to another lighting apparatus when a magnetic connector member of said lighting apparatus is magnetically attracted to an opposite poled magnetic connector member of said another lighting apparatus.

Each mating mechanism of each lighting apparatus further comprises one or more fasteners for mechanically connecting said lighting apparatus to another lighting apparatus.

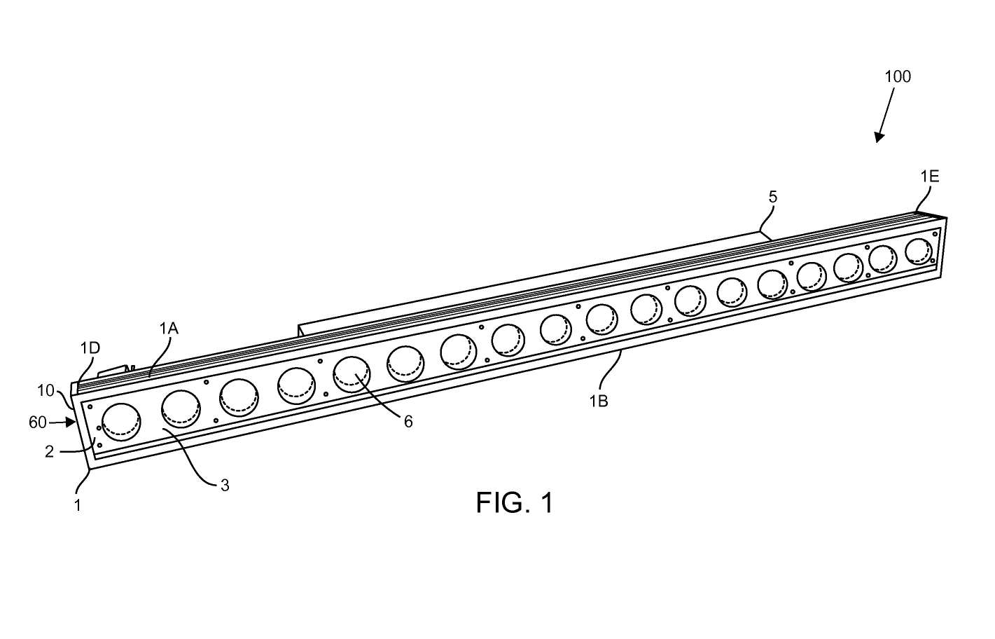

FIG. 1 illustrates a front perspective view of a lighting apparatus 100, in accordance with an embodiment of the present invention. The lighting apparatus 100 comprises a housing 1 and a control unit 5.

The housing 1 comprises a lighting panel 2. A plurality of lighting elements 6 are affixed to the lighting panel 2. The lighting elements 6 may comprise, for example, semiconductor LEDs or organic LEDs. Other light emitting elements, such as light bulbs, lasers, or liquid crystal display (LCD) panels, may also be used. The arrangement of the lighting elements 6 on the lighting panel 2 may vary. As shown in FIG. 1, in one embodiment, the lighting elements 6 on the lighting panel 2 are spaced apart horizontally.

In one embodiment, the housing 1 further comprises a transparent/translucent cover plate 3 that is fixedly but removably secured to the lighting panel 2 to protect the lighting elements 6. When the lighting elements 6 are powered on, light from the lighting elements 6 illuminates through the plate 3.

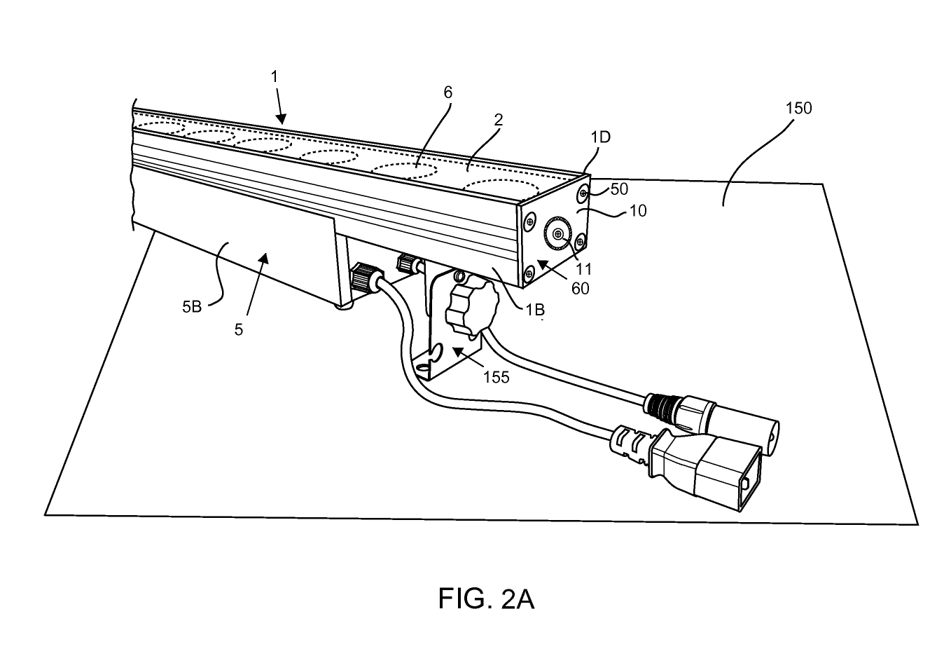

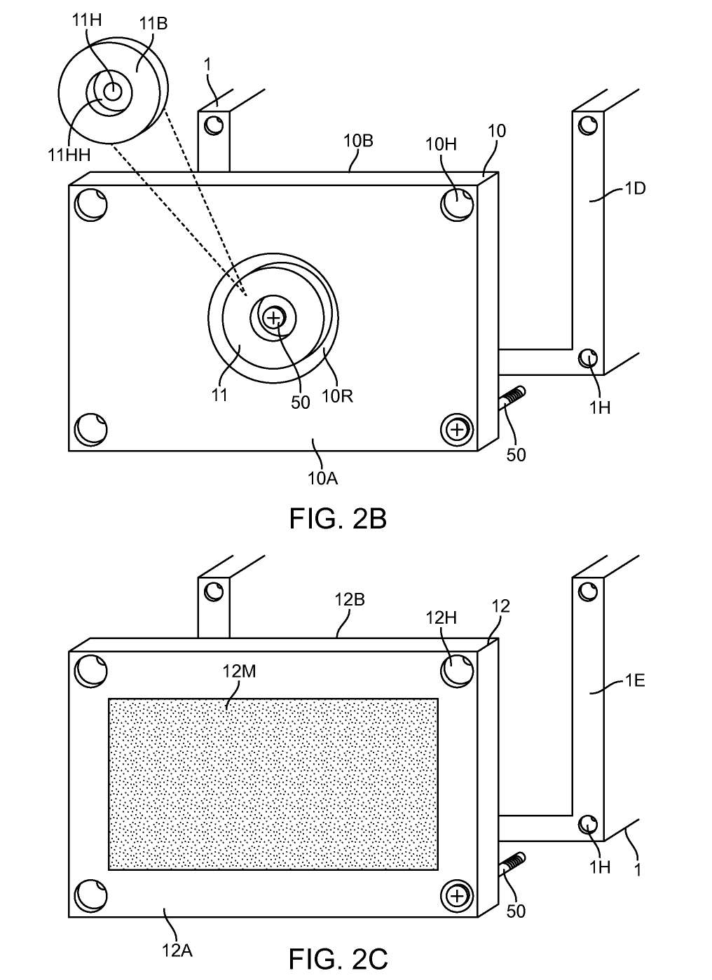

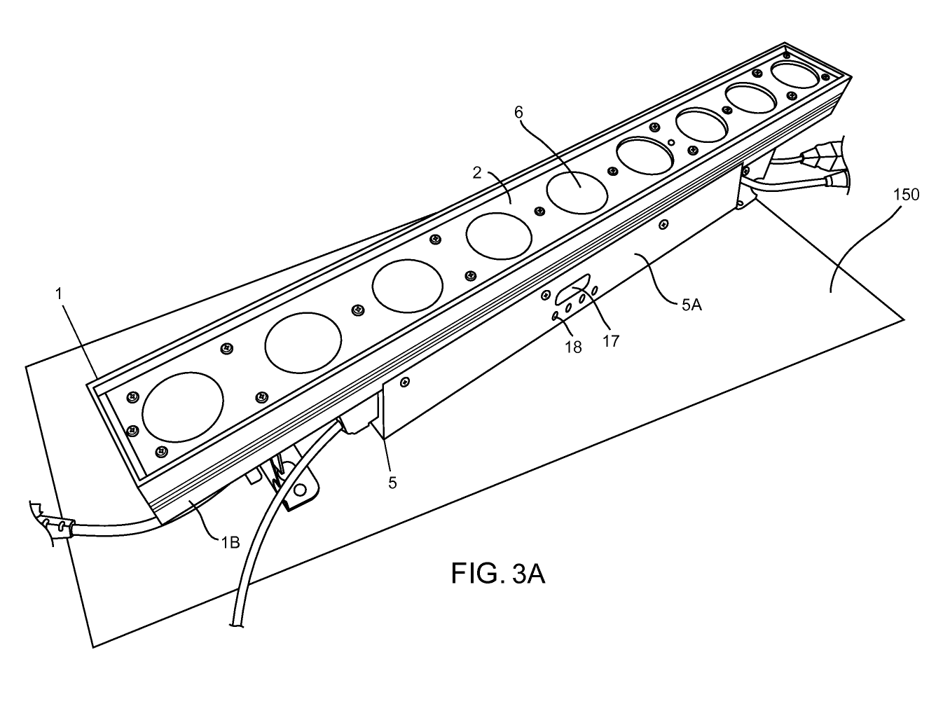

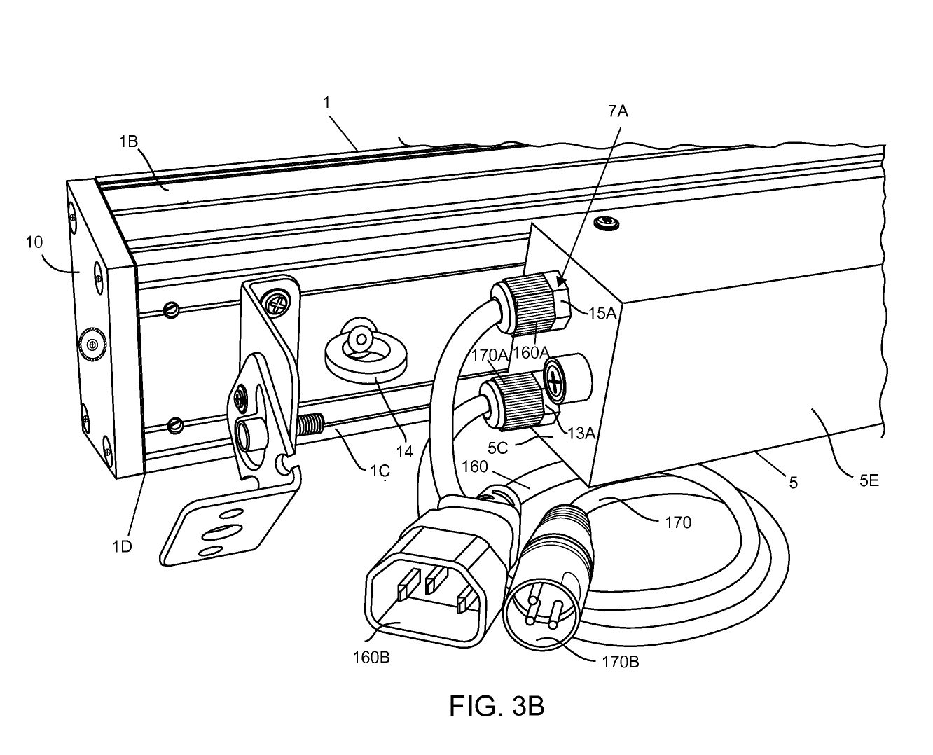

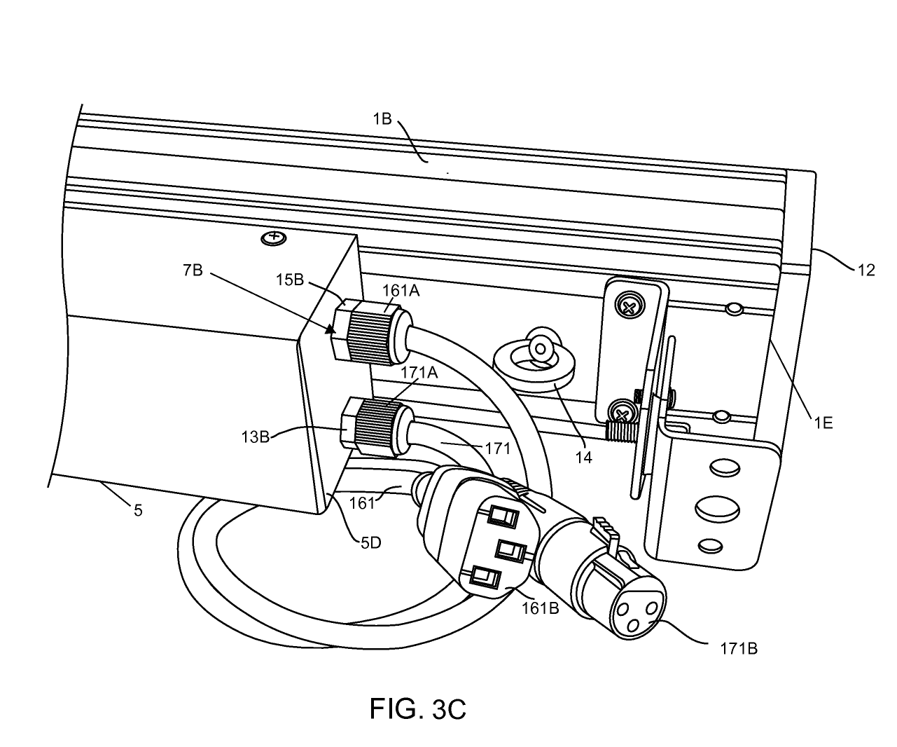

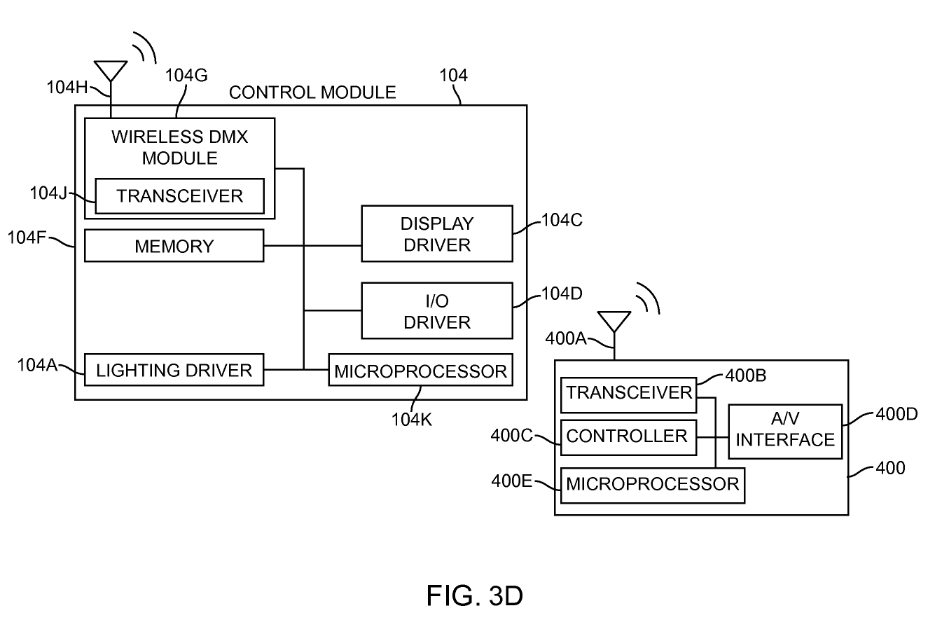

The shape of the housing 1 may vary. In one embodiment, the housing 1 has an elongated bar profile. The housing 1 has a plurality of side walls, such as first side wall 1A, a second side wall 1B (FIG. 2A), and a third side wall 1C (FIG. 3B). The first side wall 1A is substantially parallel to the second side wall 1B. The third side wall 1C extends transversely between the side walls 1A and 1B.

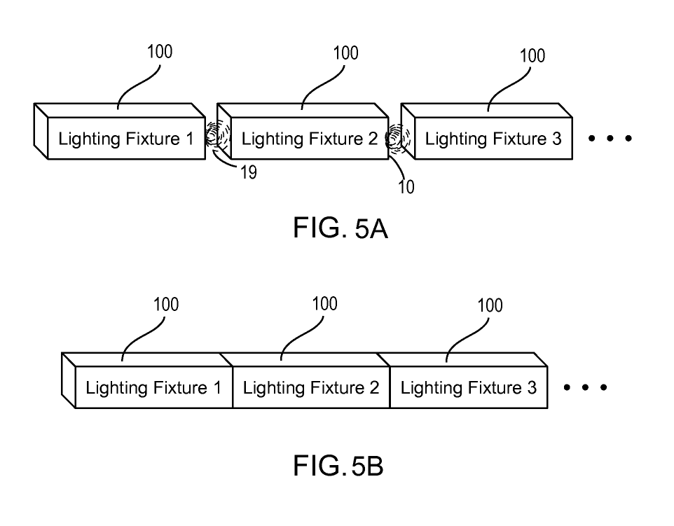

The housing 1 of the lighting apparatus 100 further comprises a mating mechanism 60 used to modularly connect the lighting apparatus 100 to at least one other lighting apparatus 100. In one embodiment, the mating mechanism 60 comprises a magnetic connector member (i.e., magnetic end cap) 10 (FIG. 2B) that is removably secured to a first end 1D of the housing 1. The mating mechanism 60 further comprises a metallic connector member (i.e., metallic end cap) 12 (FIG. 2C) that is removably secured to a second end 1E of the housing 1. The second end 1E of the housing 1 opposes the first end 1D of the housing 1. Each cap 10, 12 extends transversely between the side walls 1A, 1B, and 1C of the housing 1. A magnetic field 19 (FIG. 5A) of the magnetic connector member 10 of a first lighting apparatus 100 creates a magnetic force that attracts a metallic connector member 12 of a second lighting apparatus 100.

In another embodiment, the mating mechanism 60 comprises a first magnetic connector member 10 and a second magnetic connector member 10 that are removably secured to the first end 1D and the second end 1E of the housing 1, respectively. The first magnetic connector member 10 and the second magnetic connector member 10 may have opposite magnetic poles (e.g., the first magnetic connector member 10 has a North pole and the second magnetic connector member 10 has a South pole). A magnetic field 19 (FIG. 5A) of a magnetic connector member 10 of a first lighting apparatus 100 creates a magnetic force that attracts an opposite magnetic pole, such as an opposite poled magnetic connector member 10 of a second lighting apparatus 100.

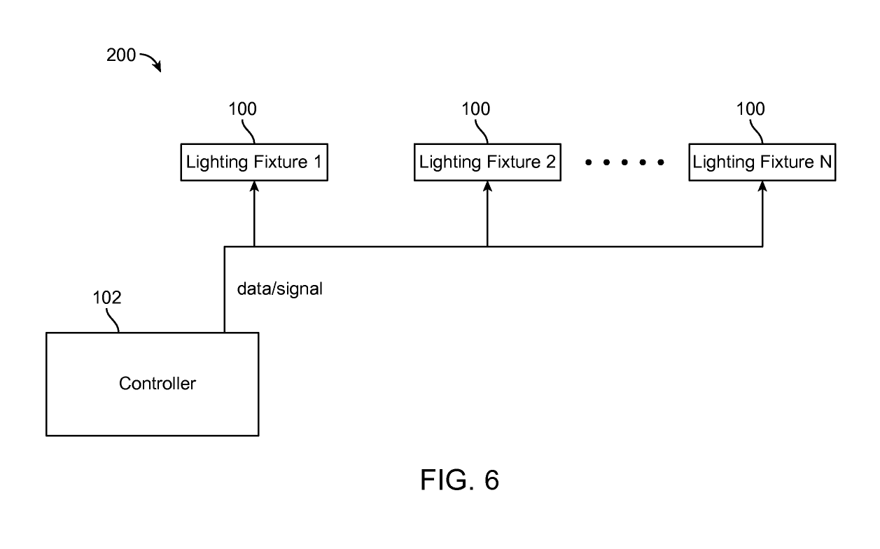

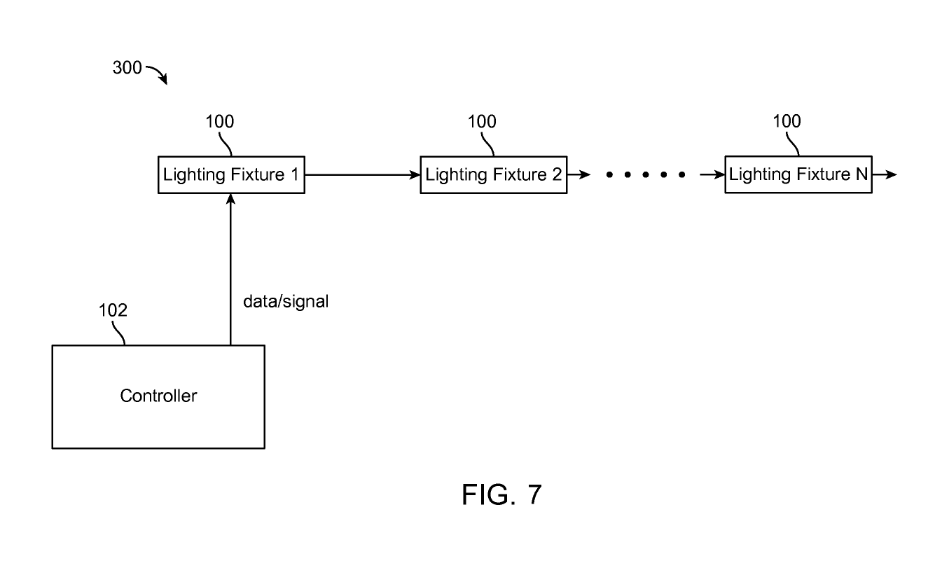

The lighting apparatus 100 can be used as a stand alone. The lighting apparatus 100 may also be used in multiples, such as in a parallel lighting circuit 200 (FIG. 6), or linked in a master/slave configuration such as a daisy-chain (i.e., serial) lighting circuit 300 (FIG. 7). The mating mechanism 60 of each lighting apparatus 100 allows multiple lighting apparatuses 100 to be connected together in a linear arrangement to form a lighting circuit, wherein the lighting apparatuses 100 are arranged end-to-end (FIG. 5B).

The control unit 5 extends rearwardly from the side wall 1C of the housing 1. The control unit 5 includes a control module 104 (FIG. 3D) disposed inside the control unit 5. As described in detail later herein, the control module 104 includes circuits for controlling the lighting effect functions of the lighting apparatus 100, such as, for example, dimming, strobing, selective activation, pulsation, color temperature, and so on.

FIG. 2A illustrates a side perspective view of a first end 1D of a lighting apparatus 100, in accordance with an embodiment of the present invention. In one embodiment, the lighting apparatus 100 further comprises a detachable mounting system 155 for mounting the lighting apparatus 100 to a floor stand or a wall, hanging the lighting apparatus 100 in a lighting grid or a truss, or positioning the lighting apparatus 100 to stand on a supporting surface (e.g., ground, table) 150. As shown in FIG. 2A, the lighting apparatus 100 is positioned to stand on a supporting surface 150.

As stated above, in one embodiment, the mating mechanism 60 comprises a magnetic connector member 10 that is removably secured to the first end 1D of the housing 1. The magnetic connector member 10 is removably secured to the first end 1D of the housing 1 using fasteners 50. Each fastener 50 may be a screw, a bolt, a stud, or the like. In another embodiment, the mating mechanism 60 comprises a first magnetic connector member 10 and a second magnetic connector member 10 that are removably secured to the first end 1D and the second end 1E of the housing 1, respectively.

Each magnetic connector member 10 comprises a magnet 11. The magnet 11 may be permanent magnet or an electromagnet. In one embodiment, the magnet 11 attracts a metallic connector member 12 of another lighting apparatus 100. In another embodiment, the magnet 11 attracts an opposite poled magnet 11 of a magnetic connector member 10 of another lighting apparatus 100.

FIG. 2B illustrates a magnetic connector member 10 of a lighting apparatus 100, in accordance with an embodiment of the invention. A magnetic connector member 10 has a front side 10A and a rear side 10B. In one embodiment, a magnetic connector member 10 is removably secured to the first end 1D of the housing 1 using at least one fastener 50.

The magnetic connector member 10 has at least one countersunk hole 10H for receiving a fastener 50. Each countersunk hole 10H of the magnetic connector member 10 extends from the front side 10A to the rear side 10B.

The first end 1D of the housing 1 has at least one countersunk hole 1H for receiving a fastener 50. To attach the magnetic connector member 10 to the first end 1D of the housing 1, each hole 10H of the magnetic connector member 10 is aligned with a corresponding hole 1H of the first end 1D. For each pair of aligned holes 10H and 1H, a fastener 50 is inserted through said pair and tightened, thereby securing the magnetic connector member 10 to the first end 1D of the housing 1. Each fastener 50 is countersunk within the front side 10A of the magnetic connector member 10.

As stated above, the magnetic connector member 10 further includes a magnet 11. The magnet 11 has a magnetic field 19 (FIG. 5A) that creates a magnetic force. The magnet 11 attracts a metallic connector member 12 of another lighting apparatus 100 when the metallic connector member 12 is placed within the magnetic field 19 of the magnet 11.

In one embodiment, the magnet 11 is countersunk within a recessed area 1 OR of the magnetic connector member 10. The magnet 11 lies flush with, and does not protrude beyond, the front side 10A of the magnetic connector member 10. The magnet 11 has an aperture 11H through which a fastener 50 may be inserted to secure the magnet 11 to the magnetic connector member 10. The magnet 11 may be replaced from wear and tear.

In one embodiment, the magnet 11 is a washer-type magnet with a barrel-shaped body 11B that includes a hollow portion 11HH. The fastener 50 is countersunk within the hollow portion 11HH of the magnet 11, and does protrude beyond the body 11B of the magnet 11.

In another embodiment, a first magnetic connector member 10 and a second magnetic connector member 10 are removably secured to the first end 1D and the second end 1E of the housing 1, respectively. The first magnetic connector member 10 and the second magnetic connector member 10 may have opposite magnetic poles (e.g., the first magnetic connector member 10 has a North pole and the second magnetic connector member 10 has a South pole). A magnetic field 19 (FIG. 5A) of the first magnetic connector member 10 of a first lighting apparatus 100 creates a magnetic force that attracts the opposite poled second magnetic member 10 of a second lighting apparatus 100.

FIG. 2C illustrates a metallic connector member 12 of a lighting apparatus 100, in accordance with an embodiment of the invention. The metallic connector member 12 has a front side 12A and a rear side 12B. The metallic connector member 12 is removably secured to the second end 1E of the housing 1 using at least one fastener 50. Specifically, the metallic connector member 12 has at least one countersunk hole 12H for receiving a fastener 50. Each countersunk hole 12H of the metallic connector member 12 extends from the front side 12A to the rear side 12B.

The second end 1E of the housing 1 has at least one countersunk hole 1H for receiving a fastener 50. To attach the metallic connector member 12 to the second end 1E of the housing 1, each hole 12H of the metallic connector member 12 is aligned with a corresponding hole 1H of the second end 1E. For each pair of aligned holes 12H and 1H, a fastener 50 is inserted through said pair and tightened, such that the metallic connector member 12 is secured to the second end 1E of the housing 1. Each fastener 50 is countersunk within the front side 12A of the metallic connector member 12.

In one embodiment, the metallic connector member 12 further includes a metallic plate 12M. When the metallic connector member 12 is placed within the magnetic field 19 (FIG. 5A) of a magnetic connector member 10 of another lighting apparatus 100, the magnetic force created by the magnetic field 19 attracts the metallic plate 12M of the metallic connector member 12. In another embodiment, the entire metallic connector member 12 is made of a metal that a magnetic connector member 10 of another lighting apparatus 100 attracts when the metallic connector member 12 is placed within the magnetic field 19 of the magnetic connector member 10.

Each connector member 10 and 12 may further include additional fasteners like screws, snaps, or treads that further mate a connector member 10 and 12 of a lighting apparatus 100 to a connector member 12 and 10 of another lighting apparatus 100, respectively. Fasteners or any temporary mechanical connections may be used in conjunction with the connector members 10 and 12, or as an alternative system, to modularly connect the lighting apparatuses 100 end to end. Each of these fasteners, including the connector members 10 and 12, may be used alone, or in combination with other connecting mechanisms.

FIG. 3A illustrates a top perspective view of a lighting apparatus 100, in accordance with an embodiment of the invention. The control unit 5 has a plurality of side walls, such as first side wall 5A, a second side wall 5B (FIG. 2A), a third side wall 5C (FIG. 3B), a fourth side wall 5D (FIG. 3C), and a fifth side wall 5E (FIG. 3B). The side walls 5A, 5B, 5C, and 5D of the control unit 5 extend rearwardly from the housing 1. The first side wall 5A is substantially parallel to the second side wall 5B, and the fourth side wall 5D opposes the third side wall 5C. The side wall 5E extends transversely between the side walls 5A, 5B, 5C, and 5D.

The first side wall 5A comprises an LCD menu control panel 17 and multiple manual control buttons 18. An operator may utilize the LCD menu control panel 17 and the manual control buttons 18 to display and control the lighting effect functions of the lighting apparatus 100, such as, for example, dimming, strobing, selective activation, pulsation, color temperature, and so on. An operator may also utilize the LCD menu control panel 17 and the manual control buttons 18 to set and display a Digital Multiplex (DMX) address for the lighting apparatus 100.

FIG. 3B illustrates a bottom perspective view of a first end 1D of a lighting apparatus 100, in accordance with an embodiment of the invention. The third side wall 5C includes at least one input socket 7A for receiving input electronic signals. In one embodiment, the third side wall 5C may comprise the following input sockets 7A: a power input socket 15A for receiving power from a power supply source (e.g., a power outlet, another lighting apparatus 100), and a data input connector 13A for receiving data control signals.

In one example implementation, the data input connector 13A is a 3-pin Digital Multiplex (DMX) input connector. In another example implementation, the data input connector 13A is a 5-pin DMX input connector. The data input connector 13A may receive DMX data instructions from a DMX controller 102 or another lighting apparatus 100.

As shown in FIG. 3B, a first end 160A of a power input cord 160 is connected to the power input socket 15A. A second end 160B of the power input cord 160 may be connected to a power supply source (e.g., a power outlet, another lighting apparatus 100) to supply power to the lighting apparatus 100.

Also shown in FIG. 3B, a first end 170A of a data input cord 170 (e.g., a DMX input cable) is connected to the data input connector 13A. A second end 170B of the data input cord 170 may be connected to a controller 102 or another lighting apparatus 100 to supply data instructions to the lighting apparatus 100.

FIG. 3C illustrates a bottom perspective view of a second end 1E of a lighting apparatus 100, in accordance with an embodiment of the invention. The fourth side wall 5D includes at least one output socket 7B for transmitting output electronic signals. In one embodiment, the fourth side wall 5D may comprise the following output sockets 7B: a power output socket 15B for transmitting power, and a data output connector 13B for transmitting data control signals.

In one example implementation, the data output connector 13B is a 3-pin DMX output connector. In another example implementation, the data output connector 13B is a 5-pin DMX output connector. The data output connector 13B may be used to transmit an outgoing DMX master/slave signal to another lighting apparatus 100.

As shown in FIG. 3C, a first end 161A of a power output cord 161 is connected to the power output socket 15B. A second end 161B of the power output cord 161 may be connected to another lighting apparatus 100.

Also shown in FIG. 3C, a first end 171A of a data output cord 171 (e.g., a DMX output cable) is connected to the data output connector 13B. A second end 171B of the data output cord 171 may be connected to another lighting apparatus 100.

Positioning the input sockets 7A and the output sockets 7B on opposing side walls 5C and 5D, respectively, facilitates the linking of the lighting apparatus 100 linked in a daisy-chain lighting circuit 300 (FIG. 7).

The side wall 1C of the housing 1 may include one or more safety rings 14 for securing the lighting apparatus 100 to a floor stand, a wall, a lighting grid, or a truss.

FIG. 3D is a block diagram illustrating a control module 104 of a lighting apparatus 100, in accordance with an embodiment of the invention. As stated above, the control module 104 is disposed inside the control unit 5 (FIG. 1). The control module 104 comprises a plurality of drivers, such as a lighting driver 104A, a display driver 104C, a power/data input/output (I/O) driver 104D, a wireless DMX module 104G, a memory unit 104F, and a microprocessor 104K.

The lighting driver 104A controls the lighting effects of the lighting elements 6. For example, the lighting driver 104A can selectively turn on or turn off each lighting element 6. The lighting driver 104A can also selectively adjust the color temperature or brightness of each lighting element 6.

The display driver 104C controls the LCD display screen 17. The power/data I/O driver 104D controls the input sockets 7A and the output sockets 7B. The microprocessor 104K is configured to process the data control signals received. The memory unit 104F maintains information such as the DMX address of the lighting apparatus 100.

The wireless DMX module 104G is configured to wirelessly communicate/exchange information (e.g., data control signals) with a wireless DMX controller 400. In one embodiment, the wireless DMX module 104G operates on one or more radio frequencies. The wireless DMX module 104G includes an antenna 104H and a wireless transceiver 104J. The antenna 104H and the transceiver 104J are configured to wirelessly receive radio frequency (RF) signals from, and wirelessly transmit RF signals to, a wireless transceiver 400B of a wireless DMX controller 400. The RF signals received include data control signals such as DMX signals. In another embodiment, the antenna 104H and the transceiver 104J wirelessly exchange information (e.g., data control signals) with a wireless DMX controller 400 using infrared (I/R) waves.

As shown in FIG. 3D, a wireless DMX controller 400 comprises an antenna 400A, a wireless transceiver 400B, a controller 400C, a microprocessor 400E, and an A/V interface 400D. The A/V interface 400D of the wireless DMX controller 400 may comprise a graphic display, and alphanumeric and directional keypads that an operator can use to enter input commands. The A/V interface 400D may comprise other types of electronic or manual data input means. The microprocessor 400E of the remote wireless DMX controller 400 is configured to process the input commands entered and generate the appropriate data control signals. The controller 400C of the wireless DMX controller 400 is configured to generate RF signals including the data controls signals generated.

The antenna 400A and the transceiver 400B of the wireless DMX controller 400 are configured to wirelessly communicate/exchange information (e.g., data control signals) with the wireless DMX module 104G of the control module 104. In one embodiment, the antenna 400A and the transceiver 400B operate on one or more radio frequencies. The antenna 400A and the transceiver 400B wirelessly receive RF signals from, and wirelessly transmit RF signals to, the wireless DMX module 104G. In another embodiment, the antenna 400A and the transceiver 400B wirelessly exchange information (e.g., data control signals) with the wireless DMX module 104G using infrared (I/R) waves.

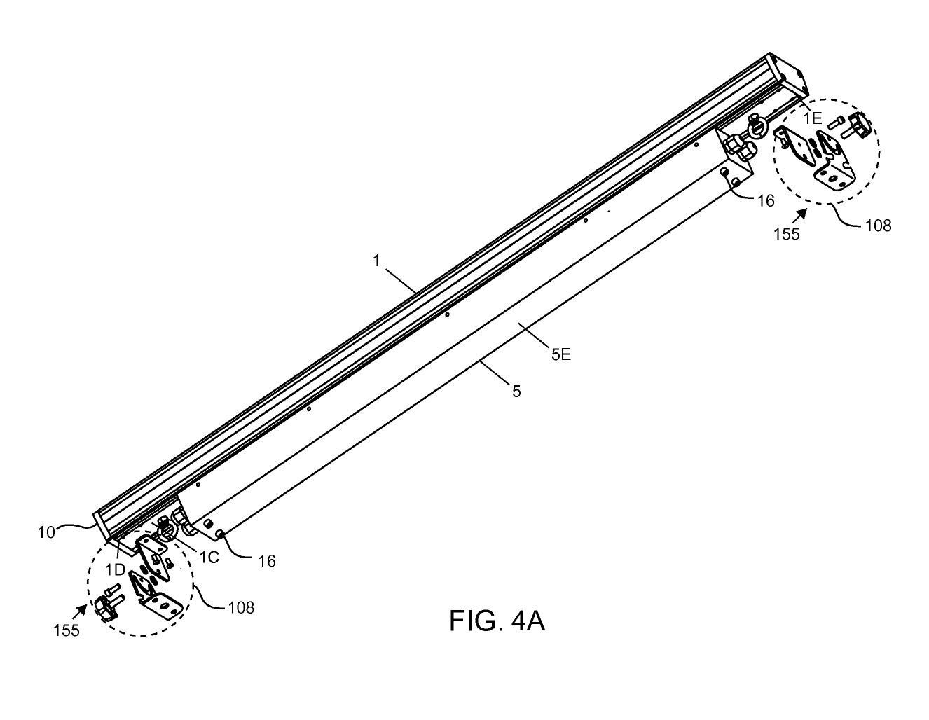

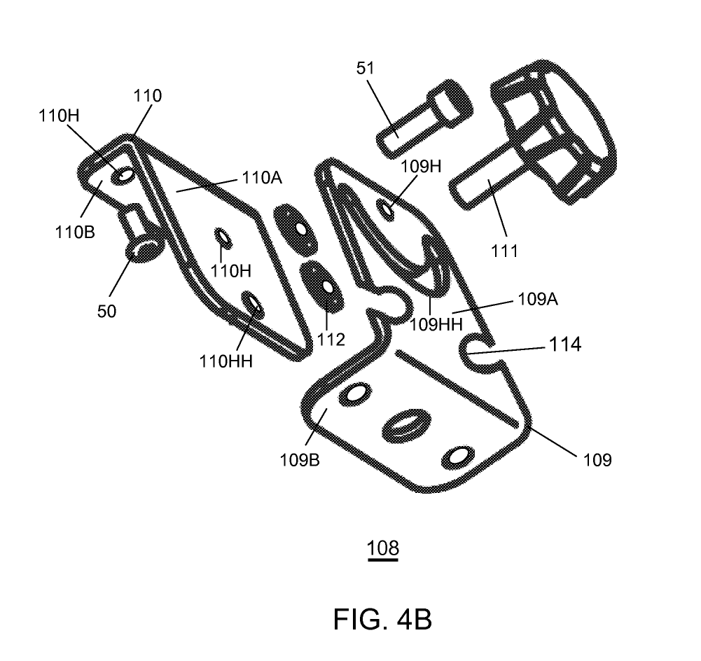

FIG. 4A illustrates a bottom perspective view of a lighting apparatus 100, in accordance with an embodiment of the present invention. In one embodiment, the mounting system 155 comprises at least one detachable mounting device 108. As shown in FIG. 4A, a first mounting device 108 is removably attached to the side wall 1C of the housing 1 at a location that is proximate to the first end 1D of the housing 1. A second mounting device 108 is removably attached to the side wall 1C of the housing 1 at a location that is proximate to the second end 1E of the housing 1.

Also shown in FIG. 4A, the fifth side wall 5E of the control unit 5 comprises multiple support members 16 (e.g., built-in feet) that are distributed evenly on the side wall 5E. When the mounting system 155 is detached from the lighting apparatus 100, the support members 16 stabilize and support the lighting apparatus 100 when the lighting apparatus 100 is positioned to sit flat on a supporting surface 150.

FIG. 4B illustrates a mounting device 108 of a lighting apparatus 100, in accordance with an embodiment of the present invention. In one embodiment, the mounting device 108 comprises a first substantially L-shaped mounting bracket 109 and a second substantially L-shaped mounting bracket 110. The brackets 109 and 110 may be made of rigid materials such as metals and the like.

The first mounting bracket 109 comprises a first flange 109A, and a second flange 109B extending transversely from the first flange 109A. The flanges 109A and 109B are integrally formed. The second mounting bracket 110 comprises a first flange 110A and a second flange 110B extending transversely from the first flange 110A. The flanges 110A and 110B are integrally formed.

The first flange 109A of the first mounting bracket 109 comprises a first aperture 109H and a second elongated aperture 109HH. The first flange 110A of the second mounting bracket 110 comprises a first aperture 110H and a second aperture 110HH. To attach the first mounting bracket 109 to the second mounting bracket 110, the apertures 109H and 109HH are aligned with the apertures 110H and 110HH, respectively. A fastener 50 is inserted through the aligned holes 109H and 110H to affix the first bracket 109 to the second bracket 110. A rotatable knob 111 or a pivot fastener 51 is inserted through the aligned holes 109HH and 110HH, thereby allowing the second bracket 110 to be pivoted relative to the first bracket 109. A washer 112 may be used to tighten the fastener 50.

The second flange 110B of the second mounting bracket 110 comprises at least one aperture 110H for receiving a fastener 50 that secures the mounting device 8 to the side wall 1C of the housing 1.

The knob 111 can be rotated to tilt the housing 1 and the control unit 5 about a substantially ninety degree angle to a desired orientation. Rotating the knob 111 in a first direction (e.g., counter-clockwise) decreases the rotary movement of the knob 11 until the knob 111 is prevented from rotating further, thereby locking the orientation of the housing 1 and the control unit 5. The knob 111 can also be rotated in a second direction (e.g., clockwise) to unlock the housing 1 and the control unit 5 from its current orientation, thereby allowing the housing 1 and the control unit 5 to tilt.

The first flange 109A of the first mounting bracket 109 further includes a first groove (i.e., notch) 114 disposed at a lateral side of the first flange 109A, and a second groove 114 disposed at an opposing lateral side of the first flange 109A. Each groove 114 may be used to retain one of the following: a power input cord 160, a data input cord 170, a power output cord 161, and a data output cord 171.

FIG. 5A illustrates multiple lighting apparatuses 100, in accordance with an embodiment of the invention. Specifically, FIG. 5A illustrates a first lighting apparatus 100 (Lighting Fixture 1), a second lighting apparatus 100 (Lighting Fixture 2), and third lighting apparatus 100 (Lighting Fixture 3). The lighting apparatuses 100 may be arranged end-to-end (i.e., abutted together) to form a daisy-chain/serial lighting circuit 300 (FIG. 7).

As described above, the magnet 11 of a magnetic connector member 10 has a magnetic field 19 that creates a magnetic force. In one embodiment, the magnet 11 attracts a metallic connector member 12 of another lighting apparatus 100 when the metallic connector member 12 is placed within the magnetic field 19 of the magnet 11.

For example, as shown in FIG. 5A, the magnetic connector member 10 of the first lighting apparatus 100 may attract the metallic connector member 12 of the second lighting apparatus 100 when the second lighting apparatus 100 comes within proximity of the magnetic field 19 of the magnetic connector member 10 of the first lighting apparatus 100. The magnetic connector member 10 of the second lighting apparatus 100 may attract the metallic connector member 12 of the third lighting apparatus 100 when the third lighting apparatus 100 comes within proximity of the magnetic field 19 of the magnetic connector member 10 of the second lighting apparatus 100. Similarly, the magnetic connector member 10 of the third lighting apparatus 100 may attract the metallic connector member 12 of another lighting apparatus 100.

In another embodiment, a magnetic connector member 10 of each lighting apparatus 100 attracts an opposite-poled magnetic connector member 10 of another lighting apparatus 100.

FIG. 5B illustrates multiple lighting apparatuses 100 that are arranged end-to-end in an example daisy-chain configuration, in accordance with an embodiment of the invention. In one example configuration, the second lighting apparatus 100 is positioned directly adjacent to the first lighting apparatus 100 by modularly connecting the magnetic connector member 10 of the first lighting apparatus 100 with the metallic connector member 12 of the second lighting apparatus 100. The third lighting apparatus 100 is positioned directly adjacent to the second lighting apparatus 100 by modularly connecting the magnetic connector member 10 of the second lighting apparatus 100 with the metallic connector member 12 of the third lighting apparatus 100.

In another embodiment, a magnetic connector member 10 of each lighting apparatus 100 is magnetically coupled to an opposite-poled magnetic connector member 10 of another lighting apparatus 100.

FIG. 6 is a block diagram illustrating multiple lighting apparatuses 100 arranged in a parallel lighting circuit 200, in accordance with an embodiment of the invention. The circuit 200 is controlled by a controller 102, such as a DMX compliant controller. Each lighting apparatus 100 receives data control signals (e.g., DMX signals) from the controller 102 via the data input connector 13A (FIG. 3B).

Each lighting apparatus 100 in the circuit 200 may also be wirelessly controlled by a wireless DMX controller 400 (FIG. 3D). As described above and illustrated in FIG. 6, a wireless DMX module 104G of each lighting apparatus 100 can wirelessly receive data control signals (e.g., DMX signals) from with a wireless DMX controller 400.

FIG. 7 is a block diagram illustrating multiple lighting apparatuses 100 linked in a daisy-chain lighting circuit 300, in accordance with an embodiment of the invention. The circuit 300 is controlled by a controller 102, such as a DMX compliant controller. In the daisy-chain circuit 300, data control signals (e.g., DMX signals) are sent as serial data that travel from one lighting apparatus 100 to another lighting apparatus 100 via the data I/O sockets 13A, 13B (FIGS. 3B-3C) of each lighting apparatus 100. Specifically, the data input connector 13A receives master/slave data control signals and the data output connector 13B transmits master/slave data control signals to the next lighting apparatus 100 in the master/slave circuit 300. For example, as shown in FIG. 7, a first lighting apparatus 100 (Lighting Fixture 1) receives data control signals from the controller 102. The first lighting apparatus 100 then transmits data control signals to a second lighting apparatus 100 (Lighting Fixture 2).

Each lighting apparatus 100 in the circuit 300 may also be wirelessly controlled by a wireless DMX controller 400 (FIG. 3D). As described above and illustrated in FIG. 5, a wireless DMX module 104G of each lighting apparatus 100 can wirelessly receive data control signals (e.g., DMX signals) from a wireless DMX controller 400.

The present invention has been described in considerable detail with reference to certain preferred versions thereof; however, other versions are possible. The above description is made for the purpose of illustrating the general principles of the present invention and is not meant to limit the inventive concepts claimed herein. Further, particular features described above can be used in combination with other described features in each of the various possible combinations and permutations. Unless otherwise specifically defined herein, all terms should be given their broadest possible interpretation including meanings implied from the specification as well as meanings understood by those skilled in the art and/or as defined in dictionaries, treatises, etc. Therefore, the spirit and scope of the appended claims should not be limited to the description of the preferred versions contained herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A lighting apparatus, comprising:
a housing for maintaining one or more lighting elements; and
a mating mechanism for connecting the lighting apparatus to at least one other lighting apparatus;
wherein the mating mechanism magnetically couples the lighting apparatus to another lighting apparatus positioned within proximity of the mating mechanism.

2. The lighting apparatus of claim 1, wherein:
the mating mechanism comprises:
a magnetic connector member at a first end of the housing; and
a metallic connector member at a second end of the housing.

3. The lighting apparatus of claim 2, wherein:
the magnetic connector member comprises a magnet having a magnetic field; and
the magnetic connector member magnetically attracts another metallic connector member positioned within proximity of the magnetic field of the magnetic connector member.

4. The lighting apparatus of claim 3, wherein:
the first end of the lighting apparatus magnetically couples to another lighting apparatus when the magnetic connector member magnetically attracts a metallic connector member of said another lighting apparatus.

5. The lighting apparatus of claim 4, wherein:
the second end of the lighting apparatus magnetically couples to another lighting apparatus when the metallic connector member is magnetically attracted to a magnetic connector member of said another lighting apparatus.

6. The lighting apparatus of claim 1, wherein:
the mating mechanism comprises:
a first magnetic connector member at a first end of the housing, wherein the first magnetic connector member has a first magnetic pole; and
a second magnetic connector member at a second end of the housing, wherein the second magnetic connector member has a second magnetic pole that is opposite of the first magnetic pole.

7. The lighting apparatus of claim 6, wherein:
each magnetic connector member comprises a magnet having a magnetic field; and
each magnetic connector member magnetically attracts an opposite poled magnetic connecter member positioned within proximity of the magnetic field of said magnetic connector member.

8. The lighting apparatus of claim 7, wherein:
the first end of the lighting apparatus magnetically couples to another lighting apparatus when the first magnetic connector member magnetically attracts an opposite poled magnetic connector member of said another lighting apparatus.

9. The lighting apparatus of claim 8, wherein:
the second end of the lighting apparatus magnetically couples to another lighting apparatus when the second magnetic connector member is magnetically attracted to an opposite poled magnetic connector member of said another lighting apparatus.

10. The lighting apparatus of claim 1, wherein:
multiple lighting apparatuses connect together when a mating mechanism of each lighting apparatus magnetically couples to a mating mechanism of another lighting apparatus;
wherein said multiple lighting apparatuses are connected end-to-end.

11. The lighting apparatus of claim 1, wherein:
the mating mechanism further comprises one or more fasteners (50) for mechanically connecting the lighting apparatus to another lighting apparatus.

12. A lighting system, comprising:
a plurality of lighting apparatuses;
each lighting apparatus comprising:
a housing for maintaining one or more lighting elements; and
a mating mechanism for connecting said lighting apparatus to at least one other lighting apparatus;
wherein the mating mechanism magnetically couples said lighting apparatus to another lighting apparatus positioned within proximity of the mating mechanism.

13. The lighting system of claim 12, wherein:
each mating mechanism of each lighting apparatus comprises:
a magnetic connector member at a first end of the housing of said lighting apparatus; and
a metallic connector member at a second end of the housing of said lighting apparatus;
wherein each magnetic connector member comprises a magnet having a magnetic field; and
wherein each magnetic connector member magnetically attracts another metallic connector member positioned within proximity of the magnetic field of said magnetic connector member.

14. The lighting system of claim 13, wherein:
the first end of each lighting apparatus magnetically couples to another lighting apparatus when the magnetic connector member of said lighting apparatus magnetically attracts a metallic connector member of said another lighting apparatus; and
the second end of each lighting apparatus magnetically couples to another lighting apparatus when the metallic connector member of said lighting apparatus is magnetically attracted to a magnetic connector member of said another lighting apparatus.

15. The lighting system of claim 12, wherein:
each mating mechanism of each lighting apparatus comprises:
a first magnetic connector member at a first end of the housing of said lighting apparatus, wherein the first magnetic connector member has a first magnetic pole; and
a second magnetic connector member at a second end of the housing of said lighting apparatus, wherein the second magnetic connector member has a second magnetic pole that is opposite of the first magnetic pole;
wherein each magnetic connector member comprises a magnet having a magnetic field; and
wherein each magnetic connector member magnetically attracts an opposite poled magnetic connecter member positioned within proximity of the magnetic field of said magnetic connector member.

16. The lighting system of claim 15, wherein:
the first end of each lighting apparatus magnetically couples to another lighting apparatus when a magnetic connector member of said lighting apparatus magnetically attracts an opposite poled magnetic connector member of said another lighting apparatus; and
the second end of each lighting apparatus magnetically couples to another lighting apparatus when a magnetic connector member of said lighting apparatus is magnetically attracted to an opposite poled magnetic connector member of said another lighting apparatus.

17. The lighting system of claim 12, wherein:
said lighting apparatuses connect together when a mating mechanism of each lighting apparatus magnetically couples to a mating mechanism of another lighting apparatus;
said lighting apparatuses are connected end-to-end; and
each mating mechanism of each lighting apparatus further comprises one or more fasteners for mechanically connecting said lighting apparatus to another lighting apparatus.

18. A method, comprising:
connecting a lighting apparatus to another lighting apparatus by positioning said another lighting apparatus within proximity of a mating mechanism of the lighting apparatus, wherein the mating mechanism magnetically couples said another lighting apparatus to the lighting apparatus.

19. The method of claim 18, further comprising:
connecting multiple lighting apparatuses together by magnetically coupling a mating mechanism of each lighting apparatus to a mating mechanism of another lighting apparatus.

20. The method of claim 19, wherein:
said multiple lighting apparatuses are connected end-to-end.
